(19) United States
(12) Patent Application Publication
(10) Pub. No.: US 2026/0094415 A1
(43) Pub. Date: Apr. 2, 2026

(54) LEARNING PROCESS VISUALIZATION SYSTEM, INFORMATION PROCESSING DEVICE, AND INFORMATION PROCESSING METHOD

(71) Applicant: Mitsubishi Electric Corporation, Tokyo (JP)

(72) Inventor: Shotaro ISHIGAMI, Tokyo (JP)

(73) Assignee: Mitsubishi Electric Corporation, Tokyo (JP)

(21) Appl. No.: 19/412,991

(22) Filed: Dec. 9, 2025

Related U.S. Application Data
(63) Continuation of application No. PCT/JP2023/022517, filed on Jun. 19, 2023.

(51) Int. Cl. G06V 10/764; G06T 5/50; G06V 10/25; G06V 10/74

(52) U.S. Cl. CPC G06V 10/764; G06T 5/50; G06V 10/25; G06V 10/761; G06T 2207/20221; G06V 2201/07

(57) ABSTRACT

A visualization result display control device includes a display control unit to perform display control of aligning and displaying a first similar portion superimposed display and a second similar portion superimposed display, the first similar portion superimposed display showing a first display superimposed on a misclassified sample, the first display visualizing a first similar portion of the misclassified sample to an extracted sample that is a sample having a feature similar to the misclassified sample, the misclassified sample being a sample that has been misclassified into a prediction class by an object detection model, and the second similar portion superimposed display showing a second display superimposed on the extracted sample, and the second display visualizing a second similar portion of the extracted sample to the misclassified sample.

### CROSS REFERENCE TO RELATED APPLICATION

This application is a Continuation of PCT International Application No. PCT/JP2023/022517, filed on Jun. 19, 2023, which is hereby expressly incorporated by reference into the present application.

### TECHNICAL FIELD

The present disclosure relates to a learning process visualization technique for visualizing and displaying a learning process of machine learning.

### BACKGROUND ART

In recent years, machine learning techniques for detecting objects have started to be used in the real world. However, from a viewpoint of a mechanism of machine learning, the process that has led to prediction is a black box, and there is a problem that it is difficult to take measures for improving accuracy of machine learning. A technique of explainable AI (XAI) is being proposed to deal with such a problem. For example, Non-Patent Literature 1 proposes a method of visualizing a prediction basis using gradient information calculated from a feature amount of a last convolutional layer of a Convolutional Neural Network (CNN) and a predicted score of the CNN in an object detection model.

### CITATION LIST

### Non-Patent Literature

Non-Patent Literature 1: Ramprasaath R. Selvaraju, Michael Cogswell, Abhishek Das, Ramakrishna Vedantam, Devi Parikh, Dhruv Batra, “Grad-CAM: Visual Explanations from Deep Networks via Gradient-based Localization”. arXiv: 1610.02391(2016)

### SUMMARY OF INVENTION

### Technical Problem

However, existing techniques require complex processing to indicate prediction bases, and therefore there is a problem that, when only a prediction basis for an incorrect prediction result is indicated, only part of the indicated display content can be understood, and it remains unclear what measures can be implemented on an object detection model to improve the object detection model.

The present disclosure has been made to solve such a problem, and an object of the present disclosure is to provide a learning process visualization technique that can contribute to giving suggestions for improving an object detection model.

### Solution to Problem

One aspect of a learning process visualization system includes processing circuitry
to search for a sample having a feature similar to a feature of a misclassified sample from a misclassified bounding box group including a group of misclassified bounding boxes, and to extract a found sample as an extracted sample, the misclassified sample being a sample that has been misclassified into a prediction class by an object detection model; and
to perform display control of aligning and displaying a first similar portion superimposed display and a second similar portion superimposed display, the first similar portion superimposed display showing a first display superimposed on the misclassified sample, the first display visualizing a first similar portion between the misclassified sample and the extracted sample, the second similar portion superimposed display showing a second display superimposed on the extracted sample, the second display visualizing a second similar portion between the extracted sample and the misclassified sample.

### Advantageous Effects of Invention

A visualization result display control device according to an embodiment of the present disclosure can contribute to giving suggestions for improving an object detection model.

### BRIEF DESCRIPTION OF DRAWINGS

FIG. 1 is a hardware configuration diagram illustrating a configuration of a learning process visualization system.

FIG. 2 is a functional block diagram illustrating a functional configuration of a sample extraction device.

FIG. 3 is a functional block diagram illustrating a functional configuration of a visualization result display control device.

FIG. 4 is a functional block diagram illustrating a functional configuration of a similar portion specifying device.

FIG. 5 is a functional block diagram illustrating a functional configuration of a misclassified BBox extraction device.

FIG. 6A is a diagram illustrating a configuration example of hardware of each device that constitutes the learning process visualization system.

FIG. 6B is a diagram illustrating a configuration example of the hardware of each device that constitutes the learning process visualization system.

FIG. 7 is a diagram illustrating an example of a display of formed visualization information.

FIG. 8 is a diagram illustrating an example of a misclassified sample display.

FIG. 9 is a diagram illustrating an example of a display format of a misclassified BBox group.

FIG. 10 is a diagram illustrating an example of a display of formed visualization information.

FIG. 11 is a diagram illustrating an example of a partially detected sample.

FIG. 12 is a flowchart illustrating an operation of the learning process visualization system.

### DESCRIPTION OF EMBODIMENTS

Various embodiments of the present disclosure will be described in detail below with reference to the accompanying drawings. Note that components assigned the identical or similar reference numerals in the drawings will have identical or similar components or functions, and redundant description of these components will be omitted.

Furthermore, a term “or” in the present disclosure is used to mean an inclusive or unless specified in particular. A case where the term “or” is used to mean an exclusive or will be explicitly indicated.

### Embodiment 1

### <Explanation of Entire System>

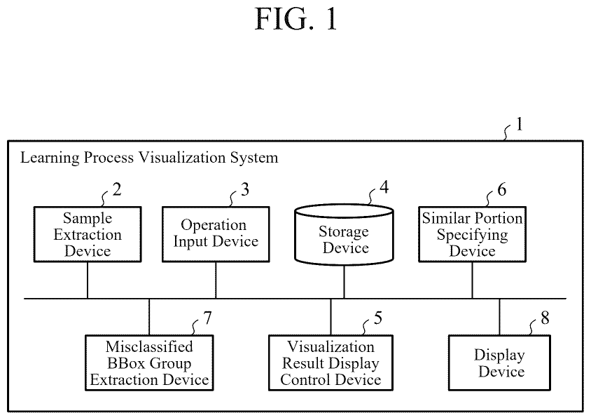

A learning process visualization system 1 according to Embodiment 1 of the present disclosure will be described with reference FIG. 1. FIG. 1 is an HW configuration diagram illustrating a configuration of the learning process visualization system 1 according to the present embodiment. As illustrated in FIG. 1, the learning process visualization system 1 includes a sample extraction device 2, an operation input device 3, a storage device 4, a similar portion specifying device 6, a misclassified BBox group extraction device 7, a visualization result display control device 5, and a display device 8. The sample extraction device 2 is a device that extracts a sample having a feature similar to a BBox (hereinafter, referred to as a “misclassified sample” in some cases) D211 misclassified by an object detection model that detects an object. As is already known, the object detection model is one type of a machine learning model. The operation input device 3 is a device that accepts an input of a user of the learning process visualization system 1 for operating the system. The storage device 4 is a device that stores existing data and the machine learning model. The similar portion specifying device 6 is a device that specifies a similar portion between the misclassified sample D211 and a selected sample D651. Note that the selected sample refers to a sample selected by a user input accepted via the operation input device 3 among one or two or more extracted samples extracted by the sample extraction device 2. The misclassified BBox group extraction device 7 is a device that extracts a group of BBox groups including all misclassified BBoxes. Note that the BBox is an abbreviation that means a bounding box. The visualization result display control device 5 is a device that performs display control of displaying a visualization result on the display device 8. The display device 8 is a device that performs display in accordance with the display control of the visualization result display control device 5. Entire control among these devices may be performed by an unillustrated control device included in the learning process visualization system 1, or may be performed by a specific device such as the visualization result display control device 5 among the devices illustrated in FIG. 1.

### <Explanation of Each Component>

Hereinafter, the devices that constitute the learning process visualization system 1 will be more specifically described.

### [Sample Extraction Device 2]

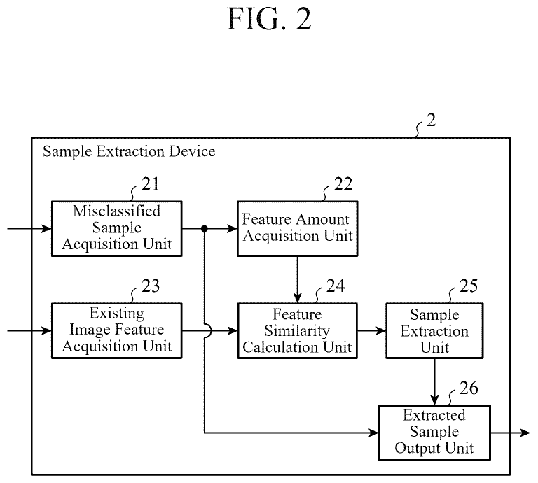

The sample extraction device 2 will be more specifically described with reference FIG. 2. FIG. 2 is a functional block diagram illustrating a functional configuration of the sample extraction device 2. As illustrated in FIG. 2, the sample extraction device 2 includes a misclassified sample acquisition unit 21, a feature amount acquisition unit 22, an existing image feature acquisition unit 23, a feature similarity calculation unit 24, a sample extraction unit 25, and an extracted sample output unit 26.

### (Misclassified Sample Acquisition Unit 21)

The misclassified sample acquisition unit 21 reads the misclassified sample D211 that is a misclassified BBox D741 selected by the user from a misclassified BBox group D751, and an original image D212 including the misclassified sample D211, and training data D213.

The misclassified BBox group means a group of misclassified samples including one or two or more misclassified samples, and the misclassified sample means a BBox for indicating a position and the size of an object for which the object detection model has determined that this object belongs to a class different from a correct class in an image showing a plurality of objects. It is sufficient that a region on the inner side of the BBox includes at least part of a detection target object, and does not need to include the entire object. The misclassified sample (BBox) is included in the misclassified BBox group together with an original image including the BBox, and related training data. In an example, such a misclassified BBox group is created in advance by the misclassified BBox group extraction device 7, and is stored in advance in the storage device 4. In another example, the misclassified BBox group may be stored in an unillustrated storage device located outside the learning process visualization system 1.

The misclassified sample acquisition unit 21 outputs the read original image D212, misclassified sample D211, and training data D213 to the extracted sample output unit 26. Furthermore, the misclassified sample acquisition unit 21 outputs the misclassified sample D211 to the feature amount acquisition unit 22. At this time, the misclassified sample acquisition unit 21 may output the original image D212 instead of the misclassified sample D211 to the feature amount acquisition unit 22.

### (Feature Amount Acquisition Unit 22)

The feature amount acquisition unit 22 extracts a misclassified sample feature amount D221 that is a feature amount of a misclassified sample from the misclassified sample D211. For example, a trained machine learning model such as a Convolutional Neural Network (CNN) can be used to extract the misclassified sample feature amount D221.

### (Existing Image Feature Acquisition Unit 23)

The existing image feature acquisition unit 23 reads all existing image feature amounts D232, D233, . . . , and D23n stored in advance from an existing image database F231 that is a database for existing images. The existing image database F231 is stored in advance in, for example, the storage device 4. In the existing image database F231, an existing image file F2311 that is a file of an existing image, a feature amount file F2312 of the existing image that is a file of a feature amount of the existing image, and training data F2313 of the existing image are held. Note that the existing image is, for example, image data used to learn or adjust a model. The existing image feature acquisition unit 23 outputs the read existing image feature amounts D232, D233, . . . , and D23n to the feature similarity calculation unit 24.

### (Feature Similarity Calculation Unit 24)

The feature similarity calculation unit 24 calculates the similarity between the misclassified sample feature amount D221 input from the feature amount acquisition unit 22 and each of the existing image feature amounts D232, D233, . . . , and D23n input from the existing image feature acquisition unit 23, and outputs similarities D241, D242, . . . , and D24n between the misclassified sample and the existing image feature amounts to the sample extraction unit 25. Here, the similarity D241 indicates the similarity between the misclassified sample feature amount D221 and the existing image feature amount D232, the similarity D242 indicates the similarity between the misclassified sample feature amount D221 and the existing image feature amount D233, and the similarity D24n indicates the similarity between the misclassified sample feature amount D221 and the existing image feature amount D23n. A general similarity calculation method such as a Euclidean distance or a cosine similarity can be used to calculate the similarity.

Furthermore, the feature similarity calculation unit 24 also outputs the existing image file F2312 to the sample extraction unit 25.

### (Sample Extraction Unit 25)

The sample extraction unit 25 extracts one or more types of extracted samples D251, D252, . . . , and D25n on the basis of all of the similarities D241, D242, . . . , and D24n input from the feature similarity calculation unit 24, and outputs the extracted extracted samples D251, D252, . . . , and D25n to the extracted sample output unit 26. To extract the extracted samples D251, D252, . . . , and D25n, one or more search patterns R251, R252, . . . , and R25n are set in advance. The sample extraction unit 25 searches for a plurality of existing images in order from an existing image having a higher similarity from the existing images (existing image file F2311), and outputs these found existing images as the extracted samples D251, D252, . . . , and D25n to the extracted sample output unit 26. Note that the sample extraction unit 25 acquires the existing images from the existing image feature acquisition unit 23 or the feature similarity calculation unit 24. Such processing is performed on all search patterns. Note that the number of samples to be extracted per search pattern may be freely set by the user.

The extracted sample may be a sample that has a feature similar to a feature of a misclassified sample, or may be a sample that has a feature similar to a feature of training data of the misclassified sample.

The sample extraction unit 25 may search for an extracted sample from the existing image file F2311 or from a misclassified BBox group other than the misclassified sample D211.

### (Extracted Sample Output Unit 26)

The extracted sample output unit 26 may output all or part of the misclassified sample D211, the original image D212, and the training data D213 input from the misclassified sample acquisition unit 21, and the extracted samples D251, D252, . . . , and D25n input from the sample extraction unit 25 outside the sample extraction device 2 on the basis of or not on the basis of a user's selection input. The user's selection input is performed via the operation input device 3, and the sample extraction device 2 accepts this selection input. Note that one or more samples selected by the user among the extracted samples D251, D252, . . . , and D25n will be referred to as selected samples D651, D652, . . . , and D65n.

### [Operation Input Device 3]

The operation input device 3 is device that accepts a user's input, and is, for example, a keyboard or a mouse. The operation input device 3 sends the accepted user's input to another device such as the sample extraction device 2.

### [Storage Device 4]

The storage device 4 stores various information, and is implemented as a storage device such as a hard disk. In the present embodiment, the storage device 4 stores a trained model that is used to infer a test image or extract a feature, and stores a test image database F41 and the existing image database F231. The test image database F41 stores a test image file F411 and training data F412 of an existing image. The test image means, for example, an image used to test such as an image used to evaluate accuracy of a trained model.

### [Visualization Result Display Control Device 5]

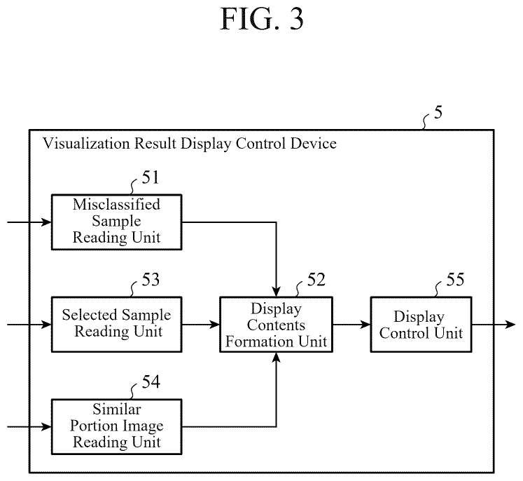

FIG. 3 is a configuration diagram illustrating a functional configuration of the visualization result display control device 5 according to the present embodiment. As illustrated in FIG. 3, the visualization result display control device 5 includes a misclassified sample reading unit 51, a selected sample reading unit 53, a similar portion image reading unit 54, a display contents formation unit 52, and a display control unit 55.

### (Misclassified Sample Reading Unit 51)

The misclassified sample reading unit 51 reads the misclassified sample D211 output from the sample extraction device 2, and sends the read misclassified sample D211 to the display contents formation unit 52.

### (Selected Sample Reading Unit 53)

The selected sample reading unit 53 reads the selected sample D651 output from the sample extraction device 2 and selected by the user, and sends the read selected sample D651 to the display contents formation unit 52.

### (Similar Portion Image Reading Unit 54)

The similar portion image reading unit 54 reads a misclassified sample similar portion image D6611 input from the similar portion specifying device 6, and one or more selected sample similar portion images D6621, D6631, . . . , and D66nN, and sends the read misclassified sample similar portion image D6611 and one or more selected sample similar portion images D6621, D6631, . . . , and D66nN to the display contents formation unit 52.

### (Display Contents Formation Unit 52)

The display contents formation unit 52 forms contents output from the misclassified sample reading unit 51, the selected sample reading unit 53, and the similar portion image reading unit 54 in a format that is easy for the user to understand, and outputs the formed contents to the display control unit 55.

### (Display Control Unit 55)

The display control unit 55 performs display control of displaying the formed contents on the display device 8. The display device 8 is, for example, a liquid crystal display device.

The visualization result display control device 5 forms each visualization information input from the sample extraction device 2 and the similar portion specifying device 6, and displays formed visualization information D511. Details of the formed visualization information D511 will be described later.

### [Similar Portion Specifying Device 6]

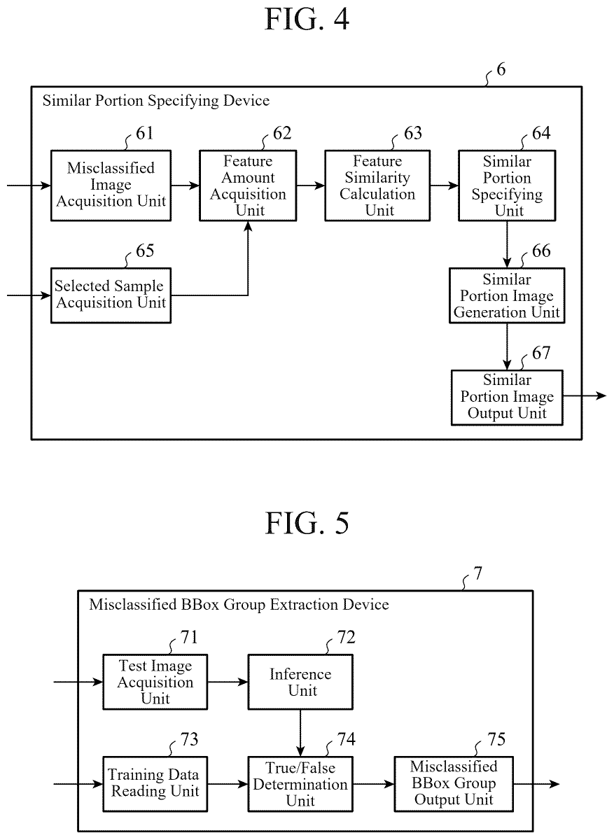

FIG. 4 is a functional block diagram illustrating a functional configuration of the similar portion specifying device 6 according to the present embodiment. As illustrated in FIG. 4, the similar portion specifying device 6 includes a misclassified image acquisition unit 61, a feature amount acquisition unit 62, a feature similarity calculation unit 63, a similar portion specifying unit 64, a selected sample acquisition unit 65, a similar portion image generation unit 66, and a similar portion image output unit 67.

### (Misclassified Image Acquisition Unit 61)

The misclassified image acquisition unit 61 reads the misclassified sample D211 selected by the user from the misclassified BBox group D751, and sends the read misclassified sample D211 to the feature amount acquisition unit 62.

### (Feature Amount Acquisition Unit 62)

The feature amount acquisition unit 62 acquires an image feature amount D621 of a misclassified sample from the misclassified sample D211 read from the misclassified image acquisition unit 61, acquires image feature amounts D622, D623, . . . , and D62n of one or more selected samples from one or more selected samples D651, D652, . . . , and D65n input from the selected sample acquisition unit 65, and outputs the acquired image feature amounts (D621, D622, D623, . . . , and D62n) to the feature similarity calculation unit 63. For example, a trained machine learning model such as a Convolutional Neural Network (CNN) can be used to acquire the feature amount.

### (Feature Similarity Calculation Unit 63)

The feature similarity calculation unit 63 calculates similarities D631, D632, . . . , and D63n between the feature amount D621 of the misclassified sample and the feature amounts D622, D623, . . . , and D62n of the selected samples per channel, and outputs the calculated similarities D631, D632, . . . , and D63n to the similar portion specifying unit 64. A general similarity calculation method such as a Euclidean distance or a cosine similarity can be used to calculate the similarity. Note that a channel refers to a variable in which information on a color, a texture, and the like is stored and that represents a feature space of a pixel, and includes three channels of a channel that indicates R (red), a channel that indicates G (green), and a channel that indicates B (blue) in a case of, for example, an RGB color space.

### (Similar Portion Specifying Unit 64)

The similar portion specifying unit 64 outputs a channel corresponding to the largest similarity among the similarities from information of the similarities D631, D632, . . . , and D63n input from the feature similarity calculation unit 63 as similar portion explanation channels D641, D642, . . . , and D64n to the similar portion image generation unit 66. Note that, in a case of an RGB image, for example, the similarity D631 includes a similarity D631R of the channel of R, the similarity D631G of the channel of G, and the similarity D631B of the channel of B. The same also applies to other D632, . . . , and D63n.

### (Selected Sample Acquisition Unit 65)

The selected sample acquisition unit 65 reads one or more samples (the selected sample D651, D652, . . . , and D65n) selected by the user from the extracted samples, and outputs the read selected samples to the feature amount acquisition unit 62.

### (Similar Portion Image Generation Unit 66)

On the basis of information of the one or more similar portion explanation channels D641, D642, . . . , and D64n input from the similar portion specifying unit 64, the similar portion image generation unit 66 creates a heat map D661 (first display) indicating a similar portion (first similar portion) of the misclassified sample, and heat maps D662, D663, . . . , and D66n (second displays) indicating similar portions (second similar portions) of one or more selected samples, and integrates the misclassified sample D211 and the one or more selected samples D651, D652, . . . , and D65n with the respective heat maps. An image obtained after integration of each sample will be referred to as the misclassified sample similar portion image D6611 and the selected sample similar portion images D6621, D6631, . . . , and D66nN. That is, the misclassified sample similar portion image D6611 is an image obtained by integrating the misclassified sample D211 and the heat map D661, and the selected sample similar portion images D6621, D6631, . . . , and D66nN are images obtained by integrating the selected samples D651, D652, . . . , and D65n and the heat maps D662, D663, . . . , and D66n, respectively. The similar portion image generation unit 66 outputs the misclassified sample similar portion image D6611 and the selected sample similar portion images D6621, D6631, . . . , and D66nN to the similar portion image output unit 67. The heat maps may be heat maps with a transparency assigned depending on differences in the similarity.

### (Similar Portion Image Output Unit 67)

The similar portion image output unit 67 outputs to another device the misclassified sample similar portion image D6611 accepted from the similar portion image generation unit 66, and the selected sample similar portion images D6621, D6631, . . . , and D66nN.

### [Misclassified BBox Group Extraction Device 7]

FIG. 5 is a functional block diagram illustrating a functional configuration of the misclassified BBox extraction device 7 according to the present embodiment. As illustrated in FIG. 5, the misclassified BBox group extraction device 7 includes a test image acquisition unit 71, an inference unit 72, a training data reading unit 73, a true/false determination unit 74, and a misclassified BBox group output unit 75.

### (Test Image Acquisition Unit 71)

The test image acquisition unit 71 reads test image data D711 from the test image database F41 stored in the storage device 4, and outputs the read test image data D711 to the inference unit 72.

(Inference Unit 72)

The inference unit 72 inputs to an inference machine the test image data D711 input from the test image acquisition unit 71, and outputs an inference result D721 that is an inference result of the inference machine to the true/false determination unit 74. For example, a trained machine learning model such as a Convolutional Neural Network (CNN) can be used as the inference machine. The inference result D721 includes the test image data D711, a BBox that indicates a position and a size of a detected object, and a prediction class obtained by predicting which class the detected object belongs.

### (Training Data Reading Unit 73)

The training data reading unit 73 reads training data D731 that is information of a position, a label, and the like of the object associated with each test image from the test image database F41 stored in the storage device 4, and outputs the read training data D731 to the true/false determination unit 74.

### (True/False Determination Unit 74)

The true/false determination unit 74 performs true/false determination on the prediction class of each BBox on the basis of the inference result D721 input from the inference unit 72, and the training data D731 input from the training data reading unit, and outputs the misclassified BBox D741, and the test image data D711 that is an original image including the misclassified BBox D741 to the misclassified BBox group output unit 75 using a BBox that has been determined as false as the misclassified BBox D741.

### (Misclassified BBox Group Output Unit 75)

The misclassified BBox group output unit 75 integrates as the misclassification BBox group D751 the one or more misclassified BBoxes D741 input from the true/false determination unit 74, the test image data D711 that is the original image including the misclassified BBoxes D741, and the training data D731, and outputs the integrated misclassified BBox group D751 to another device of the learning process visualization system 1. In this case, other data such as reliability related to the misclassified BBoxes D741 may be also included in the misclassified BBox group D751.

### Detailed Explanation of Feature Portion>

### [Formed Visualization Information]

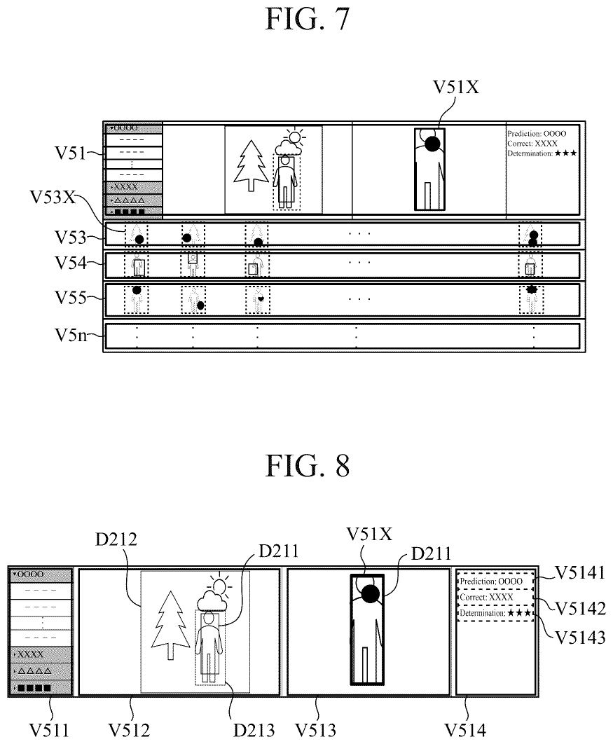

Next, the formed visualization information D511 of the visualization result display control device 5 will be described with reference to FIGS. 7 and 10. FIGS. 7 and 10 illustrate an example of a display of the formed visualization information D511.

### (Formed Visualization Information D511)

In the present embodiment, the formed visualization information D511 includes a display V51 that indicates the misclassified sample D211, one or more types of displays V53, V54, V55, . . . , and V5n that indicate one or more types of extracted samples D251, D252, . . . , and D25n similar to the misclassified sample D211, and a display V52 that indicates a similar portion between the misclassified sample D211 and the selected sample D651 selected from the extracted samples D251, D252, . . . , and D25n. The display control unit 55 may perform display control of displaying pieces of information included in the formed visualization information D511 on a plurality of regions to make it possible to identify the pieces of information included in the formed visualization information D511. For example, as illustrated in FIG. 7, the display control unit 55 may align and display the display V51, the display V53, the display V54, the display V55, . . . , and the display V5n in respectively different regions. Although the region that displays the display V51 is located at the uppermost level in the example in FIG. 7, the display V51 may be displayed to be located in another region such as the lowermost level or the middle level.

The display V52 may be part of the display V51 and part of the one or more types of the displays V53, V54, V55, . . . , and V5n. For example, as illustrated in FIG. 7, the display V52 may be a display that includes a display V51X that is part of the display V51 in FIG. 7, and a display V53X that is part of the display V53 in FIG. 7. The display V51 and the one or more types of displays V53, V54, V55, . . . , and V5n are aligned and displayed, so that the display V51X and the display V53X constituting the display V52 are also aligned and displayed.

Furthermore, the display V52 may be a display that is formed by extracting and forming part of the display V51 and part of the one or more types of displays V53, V54, V55, . . . , and V5n, and be different from the display V51 or the one or more types of the displays V53, V54, V55, . . . , and V5n. For example, as illustrated in FIG. 10, the display V52 may be a display that is formed by aligning the display V51X that is part of the display V51 in FIG. 7 and the display V53X that is part of the display V53 in FIG. 7 adjacently to each other. Hereinafter, each display that constitutes the formed visualization information D511 will be more specifically described in a new paragraph.

It is sufficient that the display V51X and the display V53X included in the display V52 are aligned and displayed, and may be displayed adjacently to each other or apart from each other. Furthermore, the display V51X and the display V53X may be aligned horizontally, vertically, or diagonally.

### (Misclassified Sample Display V51)

FIG. 8 is a diagram illustrating a detailed configuration example of the misclassified sample display V51 in FIG. 7. As illustrated in FIG. 8, the misclassified sample display V51 includes a misclassified BBox group display V511 that indicates a misclassified BBox group, a misclassification result display D512 that indicates a misclassification result, a misclassified sample scale display V513 that indicates a misclassified sample, and a BBox information display V514 that indicates information of a BBox. The display control unit 55 may perform display control of displaying pieces of information of the misclassified BBox group display V511, the misclassification result display D512, the misclassified sample scale display V513, and the BBox information display V514 in different regions to make it possible to identify the misclassified BBox group display V511, the misclassification result display D512, the misclassified sample scale display V513, and the BBox information display V514.

### (Misclassified BBox Group Display V511)

The misclassified BBox group display V511 is a display in a list format of misclassified BBox groups obtained by the afore-mentioned misclassified BBox group extraction device 7. An example of a display format is as follows. In this regard, the display format may not be this format.

### List Display Format

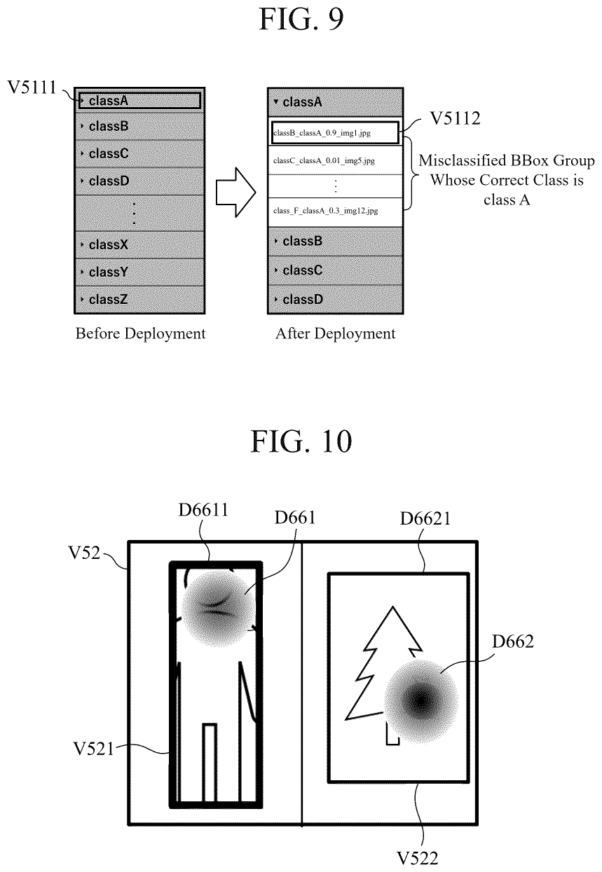

As illustrated in FIG. 9, a parent item V5111 displays a correct class, and a child item V5112 belonging to the parent item V5111 displays a group of misclassified BBoxes.

### Item Name of Child Item V5112

“<prediction class>_<correct class>_<reliability>_<original image file name>”

As described above, the misclassified BBox group display V511 is a display of a list format obtained by grouping a group of misclassified sample groups including a plurality of misclassified samples per correct class. The display control unit 55 performs display control of displaying this misclassified BBox group display V511 on the display device 8.

### (Misclassification Result Display D512)

The misclassification result display D512 is a display obtained by integrating a test image (original image D212) including the misclassified BBox (misclassified sample) D211 selected by the user, the training data D213, and a misclassified BBox (misclassified sample D211). As illustrated in FIG. 8, the original image D212 integrally shows what the training data D213 is, and at which position and what size the misclassified BBox (misclassified sample D211) is. The display control unit 55 performs display control of displaying the misclassification result display D512.

### (Misclassified Sample Scale Display V513)

The misclassified sample scale display V513 is a scale display that includes a display obtained by enlarging or reducing the misclassified sample D211. In a case where an image showing a similar portion is superimposed on the misclassified sample V211, the misclassified sample scale display V513 is a scale display that includes a display in which the similar portion superimposed display is enlarged or reduced. Enlargement or reduction may be performed on the basis of a user operation. The display control unit 55 performs display control of displaying the misclassified sample scale display V513.

### (BBox Information Display V514)

The BBox information display V514 is a display of related information related to the misclassified sample. The BBox information display V514 includes a prediction class display V5141, a correct class display V5142, and a misclassification type display V5143 of the misclassified sample. The misclassification type display V5143 is information for informing the user of the type of misclassification. As the misclassification type display V5143, for example, information of “misclassification of class”, “misclassification due to partial detection of object”, “misclassification due to detection to totally different object”, or the like is displayed. Note that information other than the above may be added for the misclassified samples.

### (Similar Portion Display V52)

FIG. 10 is a diagram illustrating a configuration example of the similar portion display V52. In the example in FIG. 10, the similar portion display D6611 in which the heat map D661 indicating a similar portion between the misclassified sample D211 and the selected sample D651 has been superimposed on the misclassified sample D211 is displayed as a similar portion superimposed display V521 (first similar portion superimposed display), and the similar portion display D6621 in which the heat map D662 indicating a similar portion between the selected sample D651 and the misclassified sample D211 has been superimposed on the selected sample D651 is displayed as a selected sample similar portion superimposed display V522 (second similar portion superimposed display). As described above, the similar portion display V52 includes the similar portion superimposed display V521 that is a display of a similar portion image obtained by superimposing an image showing a similar portion of a misclassified sample on the misclassified sample, and one or more selected sample similar portion superimposed displays V522, V523, . . . , and V52n that are displays obtained by superimposing an image showing a similar portion of a selected sample on the selected sample.

### (Extracted Sample Displays V53, V54, V55, . . . , and V5n)

The extracted sample displays V53, V54, V55, . . . , and V5n are displays of samples having higher similarities to the misclassified sample D211. A sample having a higher similarity to the misclassified sample D211 is searched for by the sample extraction device 2 using one or more search patterns R251. That is, the sample extraction device 2 extracts samples having higher similarities to the misclassified sample D211 in order from a sample having a higher similarity from the existing image database F231 or the misclassified BBox group using the one or more search patterns R251, and the visualization result display control device 5 displays the extracted samples D251, D252, . . . , and D25n that are the samples extracted by the sample extraction device 2 as the extracted sample displays V53, V54, V55, . . . , and V5n. Note that an arbitrary number of extracted samples are displayed. Hereinafter, three examples of a case where V53 represents a “similar sample”, a case where V54 represents a “partially detected sample”, and a case where V55 represents a “correct sample” will be described as examples of extracted samples according to each search pattern.

### (Misclassified Sample: V53)

Data whose prediction class is the same as that of the misclassified sample D211 and whose color, texture, or shape is similar to that of the misclassified sample D211 is displayed as a similar sample (V53). In a case where, for example, the prediction class of the misclassified sample D211 is “Dog”, an image having a class of “Dog” is extracted from the existing image database F231 in order from an image having a higher similarity to that of the misclassified sample D211, and displayed.

### (Partially Detected Sample: V54)

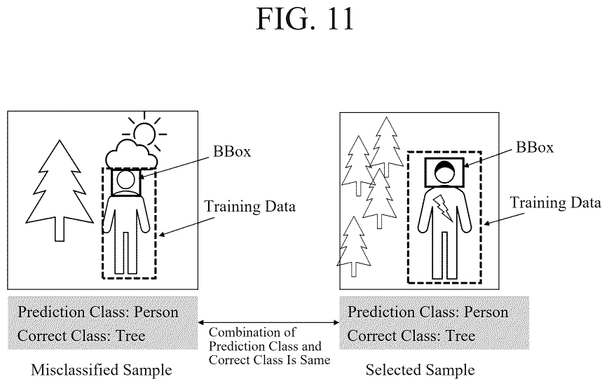

As illustrated in FIG. 11, a misclassified BBox whose both of a prediction class and a correct class are the same as those of the misclassified sample D211, and in which an object is partially detected is displayed as a partially detected sample (V54). In a case where, for example, the prediction class of the misclassified sample D211 is “Dog”, and the correct class is “Person”, a misclassified BBox that includes the prediction class of “Dog” and the correct class of “Person” and in which an object is partially detected is extracted from the misclassified BBox group in order from a misclassified BBox group having a higher similarity to that of the misclassified sample D211, and displayed.

### (Correct Sample: V55)

Data whose correction class is the same as that of the misclassified sample D211 and whose color, texture, or shape is similar to that of the misclassified sample D211 is displayed as a correct sample (V55). In a case where, for example, the correct class of the misclassified sample D211 is “Person”, an image including the class of “Person” is extracted from existing images in order from an image having a higher similarity to that of the misclassified sample D211, and displayed.

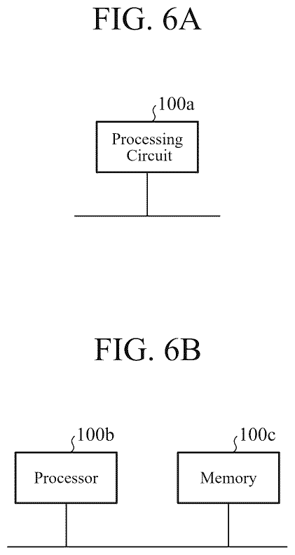

Next, a hardware configuration example of the devices included in the learning process visualization system 1 will be described with reference to FIGS. 6A and 6B. Each function of the sample extraction device 2, the visualization result display control device 5, the similar portion specifying device 6, and the misclassified BBox group extraction device 7 among the devices included in the learning process visualization system 1 is implemented by a processing circuitry. The processing circuitry may be a dedicated processing circuit 100a illustrated in FIG. 6A, or may be a processor 100b that executes programs stored in a memory 100c illustrated in FIG. 6B.

In a case where the processing circuitry is the dedicated processing circuit 100a, the dedicated processing circuit 100a corresponds to, for example, a single circuit, a composite circuit, a programmed processor, a parallel-programmed processor, an Application Specific Integrated Circuit (ASIC), a Field-Programmable Gate Array (FPGA), or a combination thereof. The functions of the above devices included in the learning process visualization system 1 may be implemented by a plurality of different processing circuits, or the functions of the devices may be collectively implemented by a single processing circuit.

In a case where the processing circuitry is the processor 100b, the functions of the above devices included in the learning process visualization system 1 may be implemented as software, firmware, or a combination of software and firmware. The software and the firmware are described as programs, and stored in the memory 100c. The processor 100b implements the function of each device by reading and executing the programs stored in the memory 100c. Here, examples of the memory 100c include a non-volatile or volatile semiconductor memory such as a Random Access Memory (RAM), a Read-Only Memory (ROM), a flash memory, an Erasable Programmable Read Only Memory (EPROM), or an Electrically Erasable programmable Read-Only Memory (EEPROM), a magnetic disk, a flexible disk, an optical disk, a compact disk, a mini disk, and a DVD.

### <Explanation of Operation>

### [Learning Process Visualization System 1]

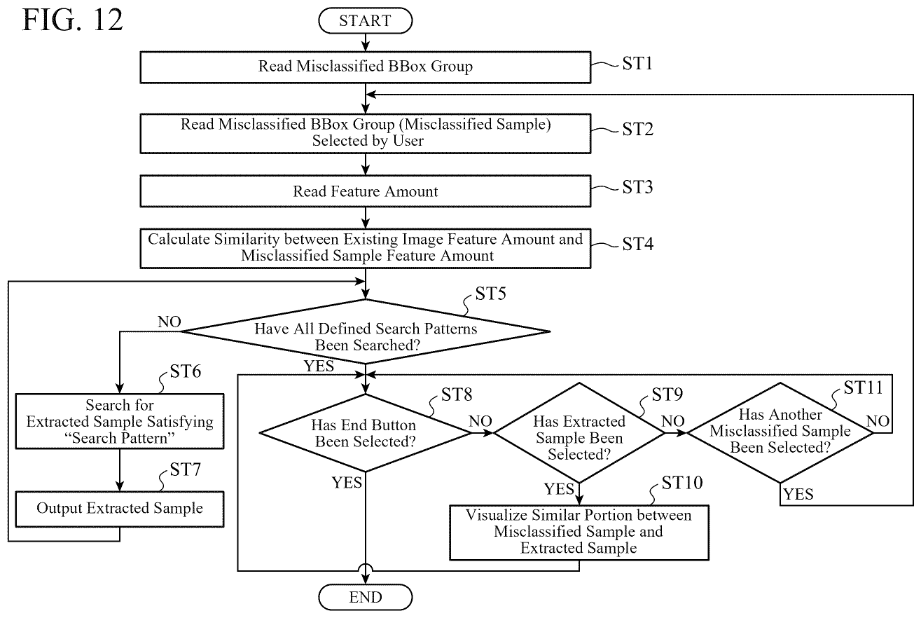

An operation of the learning process visualization system 1 will be described. A flow from input of a misclassified BBox group into the learning process visualization system 1 to visualization of a similar portion by the user will be described with reference to FIG. 12. FIG. 12 is a flowchart illustrating a series of visualization processing of the learning process visualization system 1 according to the present embodiment.

### (Step ST1)

It is assumed that the misclassified BBox group 751 created in advance by the misclassified BBox group extraction device 7 is stored in advance in the storage device 4. Under such an assumption, in step ST1, the sample extraction device 2 of the learning process visualization system 1 reads the misclassified BBox group 751 from the storage device 4. The sample extraction device 2 performs display control of outputting the read misclassified BBox group 751 to the visualization result display control device 5, converting the accepted misclassified BBox group 751 into a format of a list or the like by the visualization result display control device 5, and displaying the converted misclassified BBox group 751 on the display device 8.

### (Step ST2)

In step ST2, the user selects a certain misclassified BBox via the operation input device 3 from the misclassified BBox group 751 displayed on the display device 8. This selected misclassified BBox will be referred to as the misclassified sample D211. The misclassified sample acquisition unit 21 of the sample extraction device 2 acquires this misclassified sample D211, and outputs the acquired misclassified sample D211 to the feature amount acquisition unit 22. At this time, the misclassified sample acquisition unit 21 may output the original image D212 instead of the misclassified sample D211 to the feature amount acquisition unit 22.

Furthermore, the misclassified sample acquisition unit 21 also acquires the original image D212 and the training data D213 of the misclassified sample D211. Furthermore, the sample extraction device 2 sends the original image D212, the misclassified sample D211, and the training data D213 to the visualization result display control device 5, and the visualization result display control device 5 performs display control of displaying the original image D212, the misclassified sample D211, and the training data D213 on the display device 8.

### (Step ST3)

In step ST3, the feature amount acquisition unit 22 reads the misclassified sample feature amount D221. At this time, the feature amount acquisition unit 22 may read a feature amount of the original image D212 instead of the misclassified sample D211. For example, a trained machine learning model such as a Convolutional Neural Network (CNN) can be used to read the feature amount. Furthermore, the existing image feature acquisition unit 23 reads the one or more types of existing image feature amounts D232, D233, . . . , and D23n stored in the storage device 4.

### (Step ST4)

In step ST4, the feature similarity calculation unit 24 calculates the similarities between the misclassified sample feature amount D221 and the one or more types of existing image feature amounts D232, D233, . . . , and D23n.

### (Step ST5)

In step ST5, the sample extraction unit 25 determines whether or not search based on all search patterns R251, R252, and E25n defined in advance has been finished. In a case where search based on all of the search patterns R251, R252, and E25n has been finished (step ST5; Yes), the processing proceeds to step ST8. On the other hand, in a case where search based on all of the search patterns R251, R252, and E25n has not been finished (step ST5; No), the processing proceeds to step ST6.

### (Step ST6)

In step ST6, the sample extraction unit 25 searches for and extracts the existing image file F2311 satisfying the one or more search patterns R251, R252, and E25n in order from the existing image file F2311 having a higher similarity to the misclassified sample D211. Samples extracted as described above will be referred to as the extracted samples D251, D252, . . . , and D25n. At this time, the sample extraction unit 25 may search for and extract samples among misclassified BBox groups other than the misclassified sample D211 instead of the existing image file F2311 in order from a sample having a higher similarity to the misclassified sample D211.

### (Step ST7)

In step ST7, the sample extraction unit 25 outputs an arbitrary number of the one or more extracted samples D251, D252, . . . , and D25n extracted in step ST6 to the visualization result display control device 5 in order from an extracted sample having a higher similarity.

### (Step ST8)

In step ST8, the learning process visualization system 1 determines whether or not the user has selected an end button via the operation input device 3. In a case where the end button has been selected (step ST8; Yes), the learning process visualization system 1 ends the processing. On the other hand, in a case where the end button is not selected (step ST8; No), the processing proceeds to step ST9.

### (Step ST9)

In step ST9, the learning process visualization system 1 determines whether or not the user has selected the one or more extracted samples D251, D252, . . . , and D25n via the operation input device 3. In a case where the extracted sample D251 has been selected (step ST9; Yes), the processing proceeds to step ST10. On the other hand, in a case where the extracted sample D251 is not selected (step ST9; No), the processing proceeds to step ST11.

### (Step ST10)

Step ST10 includes a step (referred to as “step ST10-1”) performed by the similar portion specifying device 6 and a step (referred to as “step ST10-2”) performed by the visualization result display control device 5. In step ST10-1, the similar portion specifying device 6 specifies a similar portion between the misclassified sample D211 and the selected extracted sample D251, converts the misclassified sample D211 into an image (similar portion image D6611) with the heat map D661 indicating the similar portion, converts the selected extracted sample D251 into an image (similar portion image D6621) with the heat map D662 indicating the similar portion, and outputs the converted images to the visualization result display control device 5.

In other words, in step ST10-1, the similar portion specifying device 6 generates the similar portion superimposed display V521 in which a display (D661) that visualizes the similar portion of the misclassified sample D211 to the extracted sample D251 that is a sample having a feature similar to the misclassified sample D211 is superimposed on the misclassified sample D211, and the similar portion superimposed display V522 in which a display (D662) that visualizes a similar portion of the extracted sample D251 to the misclassified sample D211 is superimposed on the extracted sample D251.

In step ST10-2, the visualization result display control device 5 performs display control of aligning and displaying converted images on the display device 8. That is, in step ST10-2, the visualization result display control device 5 performs display control of aligning and displaying the generated similar portion superimposed display V521 and the generated similar portion superimposed display V522.

### (Step ST11)

In step ST11, the learning process visualization system 1 determines whether or not the user has selected another misclassified sample from the misclassified BBox group 751 via the operation input device 3. In a case where the another misclassified sample has been selected (step ST11; Yes), the processing proceeds to step ST2. On the other hand, in a case where the another misclassified sample has not been selected (step ST11; No), the processing proceeds to step ST8.

### <Explanation of Effect>

According to the above operation, the learning process visualization system 1 according to the present embodiment extracts, from the existing image database or the misclassified BBox group, samples that have features similar to misclassified samples that are samples misclassified by the object detection model. The learning process visualization system 1 aligns and displays the samples (extracted samples) extracted as the misclassified samples, and superimposes a display that visualizes similar portions between the misclassified samples and the extracted samples on both of the misclassified samples and the extracted samples. The user who sees such a display can easily grasp what feature has influenced misclassification, so that the learning process visualization system 1 can contribute to giving suggestions for improving the object detection model to the user.

Particularly, the similar portion between the misclassified sample and the extracted sample is indicated by superimposing and displaying a display that visualizes the similar portion without using a dedicated index or term, so that it is possible to provide an effect that even users who have no expertise can study improvement of the object detection model. Accordingly, the learning process visualization system 1 according to the present disclosure is suitable for introduction at, for example, a site at which an object detection AI needs to be introduced, yet there is no AI engineer. In a case where, for example, the learning process visualization system 1 that is a system that detects birds is introduced, when the birds are misclassified as different objects, the learning process visualization system 1 presents image features such as a color, a texture, a shape, and the like that cause misclassification to the user using existing images or images of another misclassified BBox. Consequently, the user can understand what image feature has caused misclassification even if the user has no expertise.

Note that the embodiments can be combined, and each embodiment can be modified or omitted as appropriate.

### INDUSTRIAL APPLICABILITY

A learning process visualization technique according to the present disclosure can be used as a technique for improving an object detection model.

### REFERENCE SIGNS LIST

1: learning process visualization system, 2: sample extraction device, 3: operation input device, 4: storage device, 5: visualization result display control device, 6: similar portion specifying device, 7: misclassified BBox group extraction device, 8: display device, 21: misclassified sample acquisition unit, 22: feature amount acquisition unit, 23: existing image feature acquisition unit, 24: feature similarity calculation unit, 25: sample extraction unit, 26: extracted sample output unit, 51: misclassified sample reading unit, 52: display contents formation unit, 53: selected sample reading unit, 54: similar portion image reading unit, 55: display control unit, 61: misclassified image acquisition unit, 62: feature amount acquisition unit, 63: feature similarity calculation unit, 64: similar portion specifying unit, 65: selected sample acquisition unit, 66: similar portion image generation unit, 67: similar portion image output unit, 71: test image acquisition unit, 72: inference unit, 73: training data reading unit, 74: true/false determination unit, 75: misclassified BBox group output unit, 100a: processing circuit, 100b: processor, 100c: memory

1. A learning process visualization system comprising:
processing circuitry
to search for a sample having a feature similar to a feature of a misclassified sample from a misclassified bounding box group including a group of misclassified bounding boxes, and to extract a found sample as an extracted sample, the misclassified sample being a sample that has been misclassified into a prediction class by an object detection model; and
to perform display control of aligning and displaying a first similar portion superimposed display and a second similar portion superimposed display, the first similar portion superimposed display showing a first display superimposed on the misclassified sample, the first display visualizing a first similar portion between the misclassified sample and the extracted sample, the second similar portion superimposed display showing a second display superimposed on the extracted sample, the second display visualizing a second similar portion between the extracted sample and the misclassified sample.

2. A learning process visualization system comprising:
processing circuitry
to search for a sample having a feature similar to a feature of training data of a misclassified sample from an existing image database that is a database of existing images, and to extract a found sample as an extracted sample, the misclassified sample being a sample that has been misclassified into a prediction class by an object detection model; and
to perform display control of aligning and displaying a first similar portion superimposed display and a second similar portion superimposed display, the first similar portion superimposed display showing a first display superimposed on the misclassified sample, the first display visualizing a first similar portion between the misclassified sample and the extracted sample, the second similar portion superimposed display showing a second display superimposed on the extracted sample, the second display visualizing a second similar portion between the extracted sample and the misclassified sample.

3. A learning process visualization system comprising:
processing circuitry
to search for a sample having a feature similar to a feature of training data of a misclassified sample from a misclassified bounding box group including a group of misclassified bounding boxes, and to extract a found sample as an extracted sample, the misclassified sample being a sample that has been misclassified into a prediction class by an object detection model; and
to perform display control of aligning and displaying a first similar portion superimposed display and a second similar portion superimposed display, the first similar portion superimposed display showing a first display superimposed on the misclassified sample, the first display visualizing a first similar portion between the misclassified sample and the extracted sample, the second similar portion superimposed display showing a second display superimposed on the extracted sample, the second display visualizing a second similar portion between the extracted sample and the misclassified sample.

4. A learning process visualization system comprising:
processing circuitry
to search for a similar sample belonging to a prediction class of a misclassified sample, and to extract a found similar sample as an extracted sample, the misclassified sample being a sample that has been misclassified into a prediction class by an object detection model; and
to perform display control of aligning and displaying a first similar portion superimposed display and a second similar portion superimposed display, the first similar portion superimposed display showing a first display superimposed on the misclassified sample, the first display visualizing a first similar portion between the misclassified sample and the extracted sample, the second similar portion superimposed display showing a second display superimposed on the extracted sample, the second display visualizing a second similar portion between the extracted sample and the misclassified sample.

5. A learning process visualization system comprising:
processing circuitry
to search for a partially detected sample, and to extract a found partially detected sample as an extracted sample, the partially detected sample being a sample belonging to a same correct class and prediction class as a correct class and a prediction class of a misclassified sample, and obtained by partially detecting an object, the misclassified sample being a sample that has been misclassified into a prediction class by an object detection model; and
to perform display control of aligning and displaying a first similar portion superimposed display and a second similar portion superimposed display, the first similar portion superimposed display showing a first display superimposed on the misclassified sample, the first display visualizing a first similar portion between the misclassified sample and the extracted sample, the second similar portion superimposed display showing a second display superimposed on the extracted sample, the second display visualizing a second similar portion between the extracted sample and the misclassified sample.

6. The learning process visualization system according to claim 1, wherein the processing circuitry is further configured to specify the first similar portion and generate the first similar portion superimposed display, and to specify the second similar portion and generate the second similar portion superimposed display.

7. The learning process visualization system according to claim 1, wherein the processing circuitry is further configured to perform display control of displaying related information related to a misclassified sample that is a target of the first similar portion superimposed display.

8. An information processing device comprising:
processing circuitry:
to acquire a first information related to a misclassified sample that is a sample misclassified into a class different from a correct class by an object detection model;
to acquire a first feature amount of the acquired first information;
to acquire an extracted sample having a second feature amount similar to the misclassified sample, on a basis of the first feature amount of the misclassified sample, from samples belonging to a prediction class to which the misclassified sample is predicted to belong by the object detection model; and
to output the acquired first information and the acquired extracted sample to a displaying device.

9. An information processing device comprising:
processing circuitry:
to acquire a first information related to a misclassified sample that is a sample misclassified into a class different from a correct class by an object detection model;
to acquire a first feature amount of the acquired first information;
to acquire an extracted sample having a second feature amount similar to the misclassified sample, on a basis of the first feature amount of the misclassified sample, from a misclassified bounding box group including a group of misclassified bounding boxes; and
to output the acquired first information and the acquired extracted sample to a displaying device.

10. The information processing device according to claim 8, wherein the first information includes any one of the misclassified sample, an original image including the misclassified sample, and training data of the misclassified sample.

11. The information processing device according to claim 8, wherein the processing circuitry is further configured to acquire the extracted sample, on a basis of a correct class of the misclassified sample, from samples belonging to the correct class.

12. The information processing device according to claim 8, wherein the processing circuitry is further configured to acquire the extracted sample, on a basis of the prediction class of the misclassified sample and the correct class of the misclassified sample, from partially detected samples that belong to the prediction class and the correct class and that are samples obtained by partially detecting an object.

13. The information processing device according to claim 8, wherein the processing circuitry is further configured to perform display control of displaying a second information that is information related to the first information, and the first information on a displaying device.

14. The information processing device according to claim 13, wherein the second information includes any one of information about a prediction class, information about a correct class, and information about a type of misclassification.

15. An information processing method comprising:
acquiring a first information related to a misclassified sample that is a sample misclassified into a class different from a correct class by an object detection model;
acquiring a first feature amount of the acquired first information;
acquiring an extracted sample having a second feature amount similar to the misclassified sample, on a basis of the first feature amount of the misclassified sample, from samples belonging to a prediction class to which the misclassified sample is predicted to belong by the object detection model; and
outputting the acquired first information and the acquired extracted sample to a displaying device.

16. An information processing method comprising:
acquiring a first information related to a misclassified sample that is a sample misclassified into a class different from a correct class by an object detection model;
acquiring a first feature amount of the acquired first information;
acquiring an extracted sample having a second feature amount similar to the misclassified sample, on a basis of the first feature amount of the misclassified sample, from a misclassified bounding box group including a group of misclassified bounding boxes; and
outputting the acquired first information and the acquired extracted sample to a displaying device.
